(19) United States
(12) Patent Application Publication
(10) Pub. No.: US 2005/0057768 A1
(43) Pub. Date: Mar. 17, 2005

(54) Method and apparatus for managing stocks of consumption units in a system of document processing devices in a network

(76) Inventors: Noura Kuppens-Ellouz, Belfeld (NL); Robertus C.W.T.M. Van Den Tillaart, Gemert (NL)

Correspondence Address: BIRCH STEWART KOLASCH & BIRCH, PO BOX 747, FALLS CHURCH, VA, 22040-0747, US

(21) Appl. No.: 10/901,053

(22) Filed: Jul. 29, 2004

(30) Foreign Application Priority Data
Aug. 1, 2003 (EP) 03077416.0

(51) Int. Cl. G06F 15/00; G03F 3/08

(52) U.S. Cl. 358/1.14; 358/1.1

(57) ABSTRACT

A method and apparatus are provided for managing stocks of consumption units associated with users in a system of document processing devices connected in a network wherein a plurality of stocks of consumption units are kept on each document processing device, each stock on a document processing device being associated with a user. The method comprises transferring, through the network, consumption units of a first stock kept on a first document processing device to a second stock kept on a second document processing device as a reaction to an emitted signal. The apparatus includes a distribution function suited for managing through the network the stocks of consumption units on a plurality of document processing devices, the stocks of consumption units being associated with the same user.

The present application claims, under 35 U.S.C. § 119, the priority benefit of European Patent Application No. 03077416.0 filed Aug. 1, 2003, the entire contents of which are herein fully incorporated by reference.

### BACKGROUND OF THE INVENTION

1. Filed of the Invention

The invention relates to a method for managing stocks of consumption units associated with users in a system of document processing devices connected in a network, wherein a plurality of stocks of consumption units are kept on each document processing device, each stock on a document processing device being associated with a user. The invention also relates to an apparatus for processing document jobs comprising document processing devices connected in a network, each document processing device comprising means for keeping a plurality of stocks of consumption units associated with users. The invention further relates to a computer program product residing on a computer readable medium comprising computer-executable instructions for causing at least one process unit to perform the method according to the invention.

2. Discussion of the Background Art

Managing stocks of consumption units is particularly of interest in an environment such as a public library, a school, etc., wherein individual users are crediting in advance an account that enables them to use a copier, a printer, a scanner, a workstation with installed software programs or any other document processing device. Generally, the account is filled by the user with currency units and the corresponding amount of money is converted into a stock of consumption units. When a document is generated by a document processing device, consumption units are withdrawn from the stock in payment for the use of the device. The amount of consumption units subtracted from the stock for an executed job may depend on the device, on the number of output sheets, on the quality of print medium, on the document that is printed, on the kind and duration of use of the software, etc.

Means for accounting an account using a signal emitted by the document processing device, the account being associated with the user are known among others from U.S. Pat. No. 5,172,398. A copying machine described therein may be provided with accounting means like a connectable key counter, a connectable coin-operated mechanism, or a connectable magnetic card reader. Such accounting means, however, are not well suited for processing document jobs like printing a document in a network environment.

U.S. Pat. No. 6,122,039 is directed to accounting means for a document processing apparatus comprising a scanner and printing hardware. Accounting means uses a signal from at least one of the scanner and the printing hardware to decrement an account associated with a user. This means is able to determine how much credit a particular user has to expend on a particular function of the apparatus. The accounting means can have access to currency input means such as a coin slot, or to a credit or debit card input. Although it would be possible to create a network with for example several scanners and printers, the user would still have to interact physically with the accounting means in order to fill the account, using coins or a card. This is cumbersome, especially in the case of a vast network.

U.S. Patent Application Publication No. 2001/0039498 A1 is directed to a charging process management system comprising image input/output devices connected to a network, a broker connected to the input/output devices through the network for providing management to the input/output devices, and a service center connected to the broker. The service center is for collecting charging information through the broker according to a use status of each of the image input/output devices. It is able to provide registration and management functions of respective user IDs, each user ID indicating one specific user. The problem, however, is that the image input/output devices can not be used by registered users when the network connecting the devices, the broker and the service center is down.

### SUMMARY OF THE INVENTION

Accordingly, it is an object of the present invention to provide an improved method for managing stocks of consumption units associated with users in a system of document processing devices connected in, a network in which the above-described problems are mitigated.

The above-mentioned object and other objects of the present invention are achieved by transferring through the network consumption units of a first stock kept on a first document processing device to a second stock kept on a second document processing device as a reaction to an emitted signal. In an environment such as a public library, a school, etc., it is common practice that registered users credit in advance a stock of consumption units in order to make use of document processing devices, for example a scanner, a printer, a copier, etc. Stocks of consumption units may be managed by a server connected through a network to the document processing devices. For example, the total amount of consumption units may be distributed over several document processing devices. That means that on each of the document processing devices available for the users, a stock is present. Upon emission of a signal, consumption units are transferred from a document processing device to another one, such that the user has access to consumption units kept on a plurality of document processing devices.

According to another aspect of the method according to the invention, transferring consumption units occurs as a reaction to a signal emitted by the second document processing device if a user has requested a document job on that second document processing device. Thus this ensures that enough consumption units are available on the document processing device whereon a document job is requested.

Transferring consumption units may occur as a reaction to a signal emitted by the second document processing device if a requested document job is processed on that second document processing device. The stock of consumption units is thus fed during processing of a document job. After that, if other devices whereon stocks are located are temporarily unavailable, there is no impact on the use of the device, because consumption units have already been transferred.

Preferably, transferring consumption units occurs as a reaction to a signal emitted by the second document processing device if the quantity consumption units of the second stock kept on the second document processing device is less than a pre-determined limit. This precaution ensures that a certain amount of consumption units is always available on a document processing device. The pre-determined limit may depend on the document processing device, on the use-behaviour of a user, etc.

An apparatus for processing document jobs according to an aspect of the invention includes a distribution function suited for managing through the network stocks of consumption units on a plurality of document processing devices connected over a network, the stocks of consumption units being associated with a same user. Thus the distribution function is aware of the quantity of consumption units on the devices connected to the network and an accurate accounting of the stocks can be carried out.

Preferably, the distribution function is suited for transferring consumption units of a first stock kept on a first document processing device to a second stock kept on a second document processing device as a reaction to an emitted signal. Transferring consumption units has the advantage that the user processing a document job on a given device can have at his disposal consumption units other than to those units kept on this given device.

The invention particularly provides an apparatus wherein the distribution function is running on a plurality of processing units on a plurality of document processing devices. This is a convenient way of implementing the distribution function.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be explained with reference to the following exemplified embodiments of the present invention, and illustrated by reference to the drawings. These embodiments serve to illustrate the invention and should not be regarded as a limitation thereof.

FIG. 1 is an example of a network system wherein an apparatus according to the invention may be implemented.

FIG. 2 shows components and logical functions of an apparatus according to the invention.

FIG. 3 is a flow diagram showing an embodiment of a method according to the invention.

FIG. 4 is a flow diagram showing another embodiment of the method according to the invention.

### DETAILED DESCRIPTION OF THE PREFERRED EMBODIMENTS

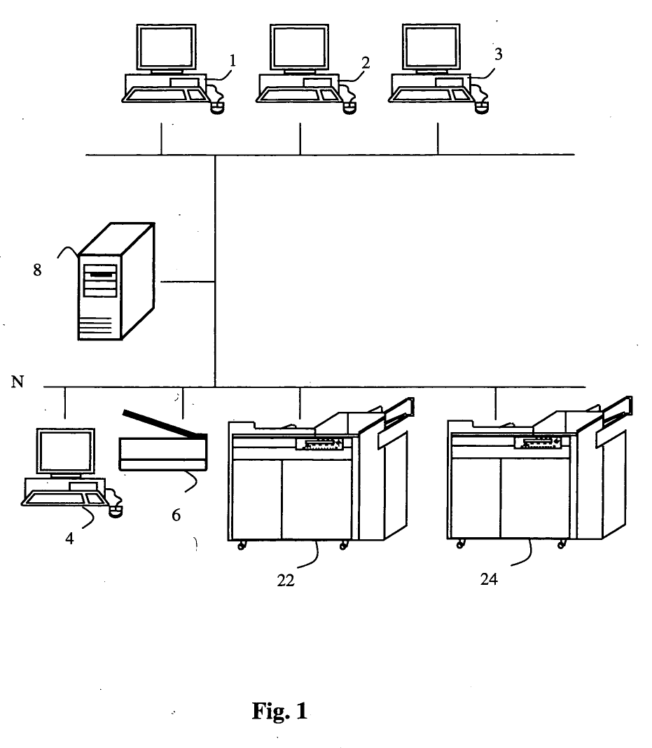

FIG. 1 shows a number of clients which can be workstations 1, 2, 3, etc. connected to each other and to a server 8 through a network N such as a local area network (LAN). Document processing devices, e.g., a workstation 4, a scanner 6, printer/copiers 22 and 24, are connected to each other through the network N. This environment can be installed for example in a public library, in a school, etc. Individual users or a pre-defined group of users may use anyone of the workstations 1, 2, 3 and send through the network N a print job to one of the document processing devices such as one of the printers 22 or 24. Users can also use directly one of the document processing devices 4, 6, 22 or 24 when they need, respectively, access to special software or to digital documents installed on the workstation 4 or on another computer connected to the network, to scan a document on the scanner 6, or to copy a document on one of the printer/copiers 22 or 24.

In an environment such as a public library or a school, it is common practice that users are registered and that they credit with currency units an associated account. An example is a bank-like system wherein the stock is managed by a server 8. The currency units credit of the user is converted into a stock of ‘consumption units’. Each time a registered user with a stock sends a print job, uses the scanner 6, or the workstation 4, or makes copies on one of the devices 22 or 24, a number of consumption units is subtracted from his associated stock. The number of consumption units that is subtracted depends on several parameters such as software used and duration of use on the workstation 4, print medium format, print medium quality, colour, use of duplex, use of staples, number of pages involved, etc., on the devices 22 or 24. It might also be that the number of consumption units depends on the selected document to be printed, for example in a public library where on-line documents are available to registered users. When this bank-like system is used, the server 8 communicates with the connected document processing devices 4, 6, 22 and 24. Each of the connected document processing devices comprises means for sending information to the server 8 about the parameters of the job required by the user. When the job is actually processed, consumption units are subtracted from the user stock as discussed above.

The apparatus according to an embodiment of the invention is now described. In a public library, for example, new users or already registered users can fill up their credit with currency units at a desk. The currency units credit of a registered user is converted into a credit of consumption units and this credit of consumption units divided into stocks of consumption units which are kept on several document processing devices. For example, the central server 8 can be provided with a distribution function running on a processor (CPU) which divides the credit of a user into stocks of consumption units to be distributed on a plurality of devices. The distribution function can be implemented with computer software alone or with some hardware. For example, suppose that a user has credited his account in such a way that it comprises in total 80 consumption units. The distribution function distributes the amount of consumption units on the devices on which the user has authorized access. For example, for a new user, the stock of the workstation 4 can be credited by 20 consumption units, the scanner 6 can be credited by 20 consumption units and the same holds for each of the printer/copiers 22 and 24. In the case that the user is already known to the distribution function, preferably the distribution function is aware of a certain behaviour of user. For example, the distribution function is aware that the user often makes use of the devices 6 and 22 and less often use of the devices 4 and 24, and accordingly the distribution function is crediting the stocks of devices 4 and 24 by less consumption units (for example 5 consumption units per device) and is crediting the devices 6 and 22 by more units (for example, 35 consumption units per device).

A user wanting to use a document processing device identifies himself on the chosen device. When a user starts to use one the devices 4, 6, 22 or 24, consumption units are withdrawn from the corresponding stock kept on the device in use. If the server is not available at the moment when the user wants to use any of the document processing devices, the user can still carry out the desired job. Since a stock filled up with consumption units is kept on the devices, the job can be carried out and the consumption units can be withdrawn from the local stock based on the performed job. Thus, it is not required that the server 8 is reachable at these moments.

On the other hand, when the server is available and a user has started to use a device, the distribution function of the server 8 notices that consumption units are subtracted from the stock of the device in use. For example, if a user starts to use the device 22 for copying documents, 20 consumption units are available at the beginning in the device 22. To avoid that the stock of device 22 reaches zero, in which case the user would be impaired to further use the device 22, the distribution function transfers consumption units, for example from other devices connected to the network, in that case the devices 4, 6, and 24, to the current device 22 in use. The distribution function may transfer 10 consumption units from each of the stocks located on the devices 4, 6 and 24, that is 30 consumption units in total, to the device 22 in use. If the user goes on with the copying jobs, some unused consumption units may be transferred again in a similar way. When the user has finished the copying job, some unused consumption units may be transferred back to the devices 4, 6 and 24 from the current device 22. In this embodiment wherein the distribution function is placed on the server, the consumption units are located on the document processing devices themselves, except during the transfers. If the server is temporarily unavailable, the copy job can still be started since the consumption units are already available on the stock kept on the document processing devices. If the server is temporarily unavailable but consumption units have been transferred to the device in use, more consumption units are available on the device and that more copies can be output than if no transfer had taken place. Possibly, the server becomes available again during the time the copying job is processed.

The transfer from a stock kept on a first device to a stock kept on a second device may take place when the amount of consumption units kept on the second device is less than a pre-determined limit. The distribution function may collect data to recognize a certain consumption use behaviour of each registered user. This ensures that an appropriate amount of consumption units is provided to devices according to certain behaviours on those devices. The distribution function may also control so that consumption units are transferred to the devices at certain moments in time, depending on the consumption behaviour of the user. For example, the distribution function may recognize that a given user is using a particular device on certain days of the week or at certain periods of a month or year. The distribution function is thus able to transfer the consumption units such that more units are available on that device for those recognized times.

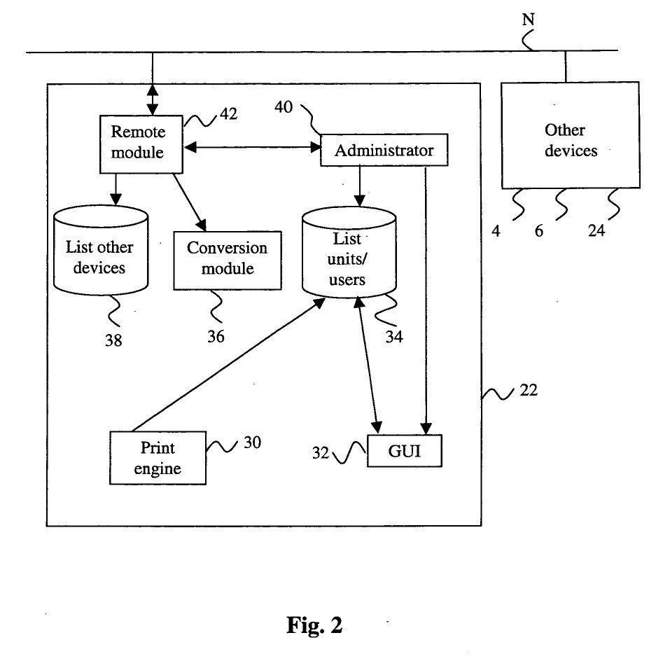

As shown in FIG. 2, the method according to the invention may be implemented on a distributed architecture. In that case, a central server is not required. Instead, a distribution function is provided that may be executed by a number of processing units (CPUs) on the document processing devices. The printer/copier device 22 comprises a print engine 30 and a Graphical User Interface (GUI) 32 whereon a registered user can log on. A remote module 42 is able to communicate with other devices 4, 6, 24 through the network N. It may thus request consumption units from other devices, each also comprising a remote module and other components. Other devices 4, 6, 24 may request consumption units through their remote module to the device 22.

The pecuniary value of a consumption unit may be device independent. A consumption unit is thus a basic unit and a document job on a device is charged for with a certain amount of consumption units. Consumption units may be transferred without conversion from a device to another and the fee in consumption units charged for a document job may be device-dependent.

On the other hand, the pecuniary value of a consumption unit may be device dependent. The printer/copier device 22 may be provided with a conversion module 36. This is useful in the case that consumption units having a device-dependent pecuniary value are transferred from a first device to another one, for example, the device 22. A conversion module on the first device converts the value of a consumption unit to be transferred into currency units. Then a certain amount of currency units is transferred to the device 22, and the conversion module 36 of the second device (device 22) can convert this credit into its consumption units and vice-versa.

The conversion module is particularly useful in the case that a consumption unit on a device does not have the same value (expressed in currency units) as on other devices. By way of example, the device 22 is a colour printer whereon the value of a consumption unit is 25 currency units, while device 24 is a monochrome printer whereon the value of a consumption unit is 3 currency units. When a consumption unit of the device 22 is to be transferred to the device 24, the conversion module 36 at the device 22 converts it into the equivalent amount of currency units and a conversion module on the device 24 converts the amount of currency units received from the device 22 into appropriate consumption units for the device 24. This is a convenient and exact way of converting consumption units from one device to another. The administrator 40 is a module for managing a list 34 of stocks of consumption units associated with different users. The administrator 40 is suited for requesting transfers of consumption units. Such a request is sent to the remote module 42 having access to the list of other devices 38, and to the local area network N. The remote module 42, the administrator 40 and the conversion module 36 are logical functions executable by a CPU (not shown) installed on the device 22. The other devices (e.g., 4, 6, 24) are provided with the same or comparable elements, in such a way that a distributed architecture can be easily implemented.

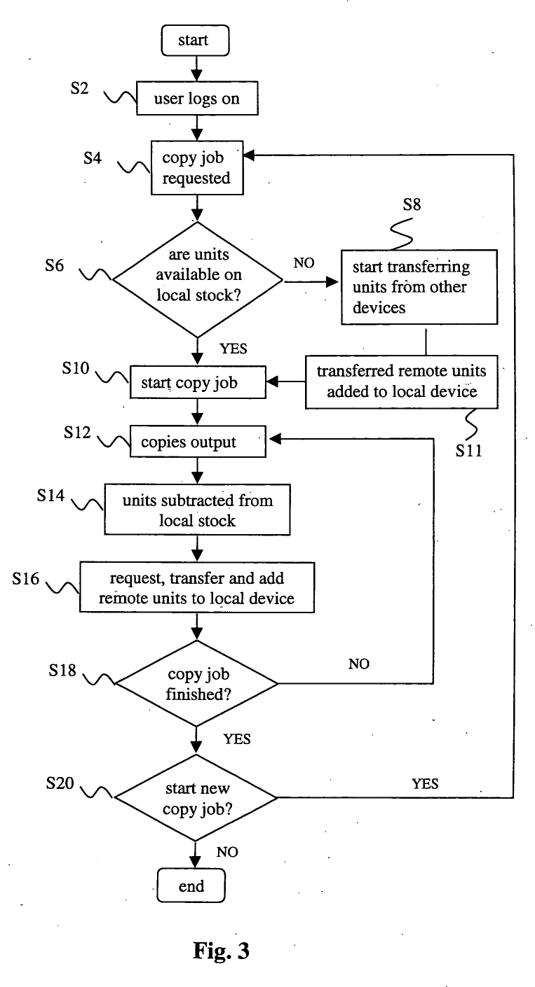

FIG. 3 is an embodiment of the method according to the invention. In this example, a distributed architecture is used and a central server is not required for transferring consumption units. Referring to FIG. 3, a registered user logs on (S2) and identifies himself using for example a pin code. In one example, the user is logged on the device 22 using, e.g., the GUI 32 and wants to carry out a copy job. Obviously, the described method applies for any document job that can be performed on any of the document processing devices 4, 6, 22, 24 connected to the network N, such as performing a print job, scanning a document, or using a workstation 4. The copy job is thus requested (S4) and it is checked (S6) whether consumption units are available on the device 22. This checking can be done by the administrator 40. If it comes out that no consumption unit is available on the device 22, a signal is generated by the device 22 and sent to the other devices 4, 6, 24 so that remote units (i.e., consumption or currency units that can be transferred in from other devices 4, 6, 24) are requested by the distribution function to the other devices 4, 6, 24. Then, the transfer of consumption units from the other devices 4, 6, 24 to the device 22 starts (S8), the transferred remote units are added (S11) to the stock of the device 22 and the copy job is started (S10). Copies are output (S12) and the consumption units are subtracted accordingly from the local stock consumption of units (S14). Request, transfer and addition of remote units to the local device may be performed again (S16). This has the advantage that even more consumption units are available on the device currently in use. In particular, this is interesting in the case that the other devices become unavailable due to failure of one or several other devices 4, 6, 24 after the step S16 has been performed. If the job is finished (S18), the user can request another copy job (S20) and the steps S6 to S18 are repeated. In a variant of this embodiment, the steps S8 and S11 of transferring and adding consumption units to the stock on the device 22 can be performed concurrently with the steps S10, S12 and S14.

In the embodiment shown in FIG. 3, if the stock of consumption units of the selected device is empty, the document job is started after transferring remote units to the selected local device. In another embodiment, in order to ensure that the user can start without delay the document job, the job is started as soon as possible after the request and a debit of consumption units is written. Concurrently, the distribution function is requesting the transfer of remote units from other devices. The requested units are transferred and the debit of units that had been written is erased.

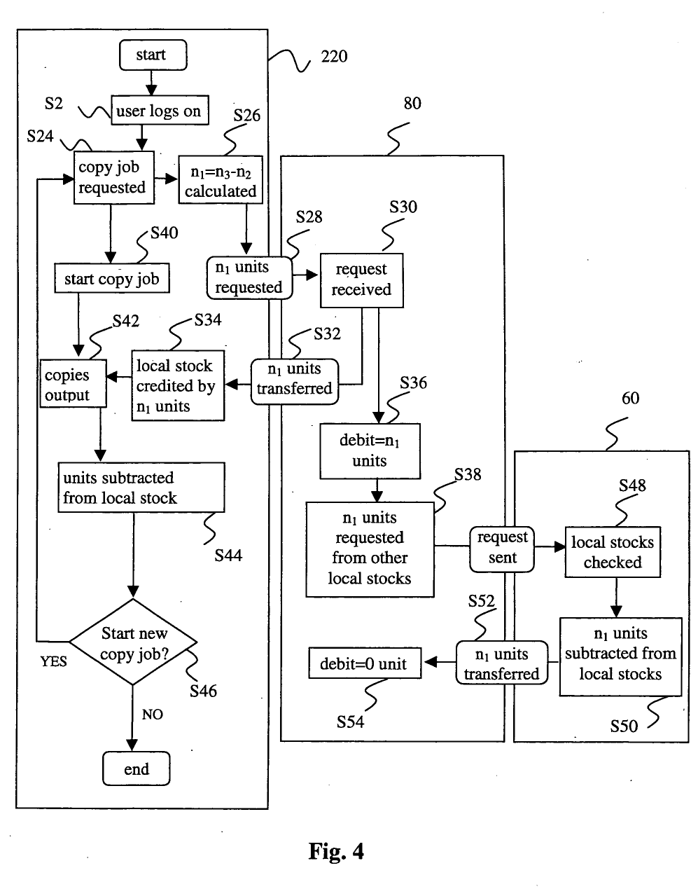

FIG. 4 shows another embodiment of the method according to the invention, wherein the distribution function is installed on a server such as the server 8. In FIG. 4, reference 220 indicates the processes occurring on the document processing device 22 in use, reference 80 indicates the processes on the server 8, and reference 60 indicates the processes on the other devices 4, 6, 24. In this example, again, the user requests a copy job. However, obviously, the described method of the invention applies for any document job that can be performed on any of the document processing devices 4, 6, 22, 24 connected to the network N, such as performing a print job, scanning a document, or using a workstation 4.

Referring to FIG. 4, in a similar way as described above, the user logs on (S2) and requests a copy job (S24). The local stock n₂ of consumption units on the device 22 is compared to the amount of consumption units n₃ needed to execute the copy job (S26). In the example, n₃ is larger than n₂ and thus it comes out that n₁ units are needed to perform the job, wherein n₁ is the difference between n₃ and n₂.

A request of n₁ units is sent (S28) by the device 22 to the server 8 over the network N or some other manner. Concurrently, the copy job is started (S40) and copies are output (S42). The server 8 receives the request (S30) sent by the device 22. As a response, the server 8 transfers (S32) the requested n₁ units to the device 22. On the device 22, the received n₁ units are added to the local stock (S34) while the copy job is being executed (S42). In the mean time, a function on the server 8 is writing a temporary debit (S36) of n₁ units and links it to the stock of the user of the device 22. The server is requesting (S38) n₁ units from the other devices connected to the network. This request is sent to the other devices 4, 6, 24 and the local stocks (in those devices 4, 6, 24) associated with the same user are checked (S48) and if one or more other devices 4, 6, 24 have available consumption units, n₁ units are subtracted (S50) from the stocks of consumption units of said other devices. n₁ units are then sent to the server 8 (S52), e.g., over the network 8, which erases the debit that was temporary written, such that the debit reaches zero (S54). Concurrently, on the device 22, processing of the copy job continues i.e. copies are output (S42) and accordingly, consumed units are subtracted (S44) from the local stock. When the job is finished, the user can decide to start another job (S46) in which case the steps S24 to S44 and S48 to S54 are repeated. Otherwise, the program is terminated.

The processing steps of the present invention are implementable using existing computer programming language. Such computer program(s) may be stored in memories such as RAM, ROM, PROM, etc. associated with computers. Alternatively, such computer program(s) may be stored in a different storage medium such as a magnetic disc, optical disc, magneto-optical disc, etc. Such computer program(s) may also take the form of a signal propagating across the Internet, extranet, intranet or other network and arriving at the destination device for storage and implementation. The computer programs are readable using a known computer or computer-based device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for managing stocks of consumption units associated with users in a system of document processing devices connected over a network, wherein a plurality of stocks of consumption units are kept on each document processing device, each stock on a document processing device being associated with a user, the method comprising:
transferring, through the network, consumption units of a first stock kept on a first document processing device to a second stock kept on a second document processing device in response to a signal.

2. The method for managing stocks of consumption units according to claim 1, wherein the signal is generated by the second document processing device if a user has requested a document job on said second document processing device.

3. The method for managing stocks of consumption units according to claim 1, wherein the signal is generated by the second document processing device if a requested document job is being processed on said second document processing device.

4. The method for managing stocks of consumption units according to claim 1, wherein the signal is generated by the second document processing device if a total amount of consumption units of the second stock kept on the second document processing device is less than a pre-determined amount.

5. The method for managing stocks of consumption units according to claim 1, wherein the signal is transmitted to the first document processing device time-dependently through the network.

6. The method for managing stocks of consumption units according to claim 1, wherein the signal is transmitted through the network, and is dependent on a consumption behaviour of the user.

7. The method for managing stocks of consumption units according to claim 1, further comprising:
converting currency units into consumption units.

8. A method for managing stocks of consumption units associated with users in a system of document processing devices connected over a network, wherein a plurality of stocks of consumption units are kept on each document processing device, each stock on a document processing device being associated with a user, the method comprising:
transferring, through the network, consumption units of a first stock kept on a server to a second stock kept on a first document processing device in response to a signal.

9. The method for managing stock of consumption units according to claim 8, wherein the signal is generated by the first document processing device if there is insufficient amount of consumption units to perform a document job.

10. The method for managing stock of consumption units according to claim 8, further comprising:
receiving, by the server, a certain amount of consumption units from a second document device in association with a current user; and
adjusting a debit amount of the current user according to the received consumption unit amount from the second document processing device.

11. An apparatus for processing document jobs, comprising:
document processing devices connected over a network, each document processing device comprising means for keeping a plurality of stocks of consumption units associated with users; and
a distribution function suited for managing through the network stocks of consumption units on a plurality of document processing devices, said stocks of consumption units being associated with a same user.

12. The apparatus for processing document jobs according to claim 11, wherein the distribution function is suited for transferring consumption units of a first stock kept on a first document processing device to a second stock kept on a second document processing device in response to a signal.

13. The apparatus for processing document jobs according to claim 11, wherein the distribution function is running on a processing unit of a server connected to the network.

14. The apparatus for processing document jobs according to claim 11, wherein each document processing device comprises a processing unit, and the distribution function is running on a plurality of processing units on a plurality of document processing devices.

15. A system for managing stocks of consumption units associated with users, the system comprising:
a plurality of document processing devices connected over a network, wherein a plurality of stocks of consumption units are kept on each document processing device, each stock on a document processing device being associated with a user; and
means for transferring, through the network, consumption units of a first stock kept on a first document processing device to a second stock kept on a second document processing device in response to a signal.

16. A system managing stocks of consumption units associated with users, the system comprising:
a plurality of document processing devices connected over a network, wherein a plurality of stocks of consumption units are kept on each document processing device, each stock on a document processing device being associated with a user;
a server coupled to the network; and
means for transferring, through the network, consumption units of a first stock kept on the server to a second stock kept on a first document processing device in response to a signal.

17. A computer program product embodied on at least one computer-readable medium, for managing stocks of consumption units associated with users in a system of document processing devices connected over a network, wherein a plurality of stocks of consumption units are kept on each document processing device, each stock on a document processing device being associated with a user, the product comprising computer-executable instructions for:
transferring, through the network, consumption units of a first stock kept on a first document processing device to a second stock kept on a second document processing device in response to a signal.

18. The computer program product according to claim 17, wherein the signal is generated by the second document processing device if a user has requested a document job on said second document processing device.

19. The computer program product according to claim 17, wherein the signal is generated by the second document processing device if a requested document job is being processed on said second document processing device.

20. The computer program product according to claim 17, wherein the signal is transmitted through the network, and is dependent on a consumption behaviour of the user.

21. The computer program product according to claim 17, further comprising computer-executable instructions for:
converting currency units into consumption units.

22. A computer program product embodied on at least one computer-readable medium, for managing stocks of consumption units associated with users in a system of document processing devices connected over a network, wherein a plurality of stocks of consumption units are kept on each document processing device, each stock on a document processing device being associated with a user, the product comprising computer-executable instructions for:
transferring, through the network, consumption units of a first stock kept on a server to a second stock kept on a first document processing device in response to a signal.

23. The computer program product according to claim 22, wherein the signal is generated by the first document processing device if there is insufficient amount of consumption units to perform a document job.

24. The computer program product according to claim 22, further comprising computer-executable instructions for:
receiving, by the server, a certain amount of consumption units from a second document device in association with a current user; and
adjusting a debit amount of the current user according to the received consumption unit amount from the second document processing device.
